(19) United States
(12) Patent Application Publication
(10) Pub. No.: US 2024/0331355 A1
(43) Pub. Date: Oct. 3, 2024

(54) Synchronous Processing Method, System, Storage medium and Terminal for Image Classification and Object Detection

(71) Applicant: Shanghai Midu Science and Technology Co., LTD., Shanghai (CN)

(72) Inventors: Ou KONG, Shanghai (CN); Yidong LIU, Shanghai (CN); Jun WANG, Shanghai (CN)

(73) Assignee: Shanghai Midu Science and Technology Co., LTD., Shanghai (CN)

(21) Appl. No.: 18/579,514

(22) PCT Filed: Apr. 27, 2022
(86) PCT No.: PCT/CN2022/089446

§ 371 Date: Jan. 16, 2024

(30) Foreign Application Priority Data
Oct. 12, 2021 (CN) 202111185199.6

(51) Int. Cl. G06V 10/764; G06T 5/20; G06V 10/771

(52) U.S. Cl. CPC G06V 10/764; G06T 5/20; G06V 10/771; G06T 2207/20084; G06V 2201/07

(57) ABSTRACT

The present disclosure provides a synchronous processing method, system, storage medium and terminal for image classification and object detection. The method includes the following steps: inputting the image into a neural network to perform a first convolution operation to obtain a first feature map; performing sequentially a second convolution operation, a pooling operation and a nonlinear function activation operation on the first feature map to obtain a second feature map, obtaining the object detection result of the image based on the second feature map; performing in sequence a global average pooling operation and a full connection operation on the first feature map to obtain the classification result of the image. The synchronous processing method, system, storage medium and terminal for image classification and object detection of the present disclosure simultaneously perform image classification and object detection through the same neural network, thus effectively reducing system load.

### TECHNICAL FIELD

The present disclosure relates to the technical field of image processing, and in particular to a synchronous processing method, system, storage medium and terminal for image classification and object detection.

### BACKGROUND OF THE INVENTION

With the rapid development of internet technology, the amount of information continues to increase, showing geometric-level growth. The amount of information is growing much faster than humans can comprehend, and is flooding into human life from all directions like a wave. In particular, to provide users with more interesting information, it is distributed usually through images. Therefore, images need to be classified and object categorized to distribute these images to interested users.

In the existing technology, image classification and object detection are usually implemented using two different models. As a result, the same image needs to be input to two different models separately to obtain the image classification results and object detection results respectively. Therefore, the above method is cumbersome and increases the system load.

### SUMMARY OF THE INVENTION

The present disclosure provides a synchronous processing method, a system, a storage medium and a terminal for image classification and object detection, which can simultaneously perform image classification and object detection through the same neural network, thus effectively reducing system load.

The present disclosure provides a synchronous processing method for image classification and object detection, which includes the following steps: inputting the image into a neural network for a first convolution operation to obtain a first feature map; performing sequentially, on the first feature map, a second convolution operation, a pooling operation and a non-linear function activation operation to obtain a second feature map to obtain the image object detection result based on the second feature map; and performing sequentially, on the first feature map, a global average pooling operation and a full connection operation to obtain the image classification result.

In an embodiment of the present disclosure, the neural network adopts Mobilenet neural network.

In an embodiment of the present disclosure, the neural network includes a first convolution module, a second convolution module, a pooling module, a nonlinear function activation module, a global average pooling module, and a full connection operation module. Herein the first convolution module is connected to both the second convolution module and the global average pooling module. The second convolution module, the pooling module and the nonlinear function activation module are connected in sequence. The global average pooling module is connected to the full connection operation module. The first convolution module performs a convolution operation on the image, and the second convolution module performs a convolution operation on the first feature map. The pooling module performs a pooling operation. The nonlinear function activation module performs a nonlinear function activation operation. The global average pooling module performs a global average pooling operation. The full connection operation module performs a full connection operation.

In an example of the present disclosure, the pixels of the first feature map are 26*26*512.

In an example of the present disclosure, a convolution kernel of 75*3*3 is used to perform a convolution operation on the first feature map, and the pixels of the second feature map are 26*26*75.

In an example of the present disclosure, after performing a global average pooling operation on the first feature map, 512 numbers are obtained, and after performing a full connection operation on the 512 numbers, 1000 numbers are obtained to provide the classification result.

In an example of the present disclosure, the neural network adopts the Tensorflow deep learning framework.

The present disclosure provides a synchronous processing system for image classification and object detection, including a convolution module, an object detection module and a classification module.

The convolution module inputs the image into the neural network for a first convolution operation to obtain the first feature map.

The object detection module sequentially performs a second convolution operation, a pooling operation and a nonlinear function activation operation on the first feature map to obtain a second feature map, so as to obtain the object detection result of the image based on the second feature map.

The classification module sequentially performs a global average pooling operation and a full connection operation on the first feature map to obtain the classification result of the image.

The present disclosure also provides a storage medium on which a computer program is stored. When the program is executed by a processor, the above synchronous processing method for image classification and object detection will be implemented.

The present disclosure also provides a synchronous processing terminal for image classification and object detection, which includes: a processor and a memory.

The memory stores computer programs.

The processor executes the computer programs stored in the memory, so that the synchronous processing terminal for image classification and object detection executes the above synchronous processing method for image classification and object detection.

As mentioned above, the synchronous processing method, system, storage medium and terminal for image classification and object detection of the present disclosure have the following beneficial effects:
(1) image classification and object detection are performed simultaneously through the same neural network, so the technique is fast and efficient;
(2) the computational complexity is low, thus effectively reducing the system load;
(3) the method is feasible, effective and highly practical in actual application scenarios.

### BRIEF DESCRIPTION OF DRAWINGS

FIG. 1 shows a flow chart of a synchronous processing method of image classification and object detection according to one embodiment of the present disclosure.

FIG. 2 shows a schematic structural diagram of a synchronous processing system for image classification and object detection according to one embodiment of the present disclosure.

FIG. 3 shows a schematic structural diagram of a synchronous processing terminal for image classification and object detection according to one embodiment of the present disclosure.

### Reference Numerals

21 Convolution module
22 Object detection module
23 Classification module
31 Processor
32 Memory

### DETAILED DESCRIPTION OF THE INVENTION

The following describes the embodiments of the present disclosure through specific examples. Those skilled in the art can easily understand other advantages and effects of the present disclosure from the content disclosed in this specification. The present disclosure can also be implemented or applied through other different specific embodiments. Various details in this specification can also be modified or changed in various ways based on different viewpoints and applications without departing from the spirit of the present disclosure.

It should be noted that the diagrams provided in this embodiment only illustrate the basic concept of the present disclosure in a schematic manner. The drawings only show the components related to the present disclosure and do not follow the actual implementation of the component numbers, shapes and sizes. In actual implementation, the type, quantity and proportion of each component can be arbitrarily changed, and the component layout may also be more complex.

The synchronous processing method, system, storage medium and terminal of image classification and object detection of the present disclosure only need one neural network to perform image classification and object detection at the same time, which simplifies the system architecture, effectively reduces the system load, and thus being extremely practical. Preferably, the neural network adopts Mobilenet neural network and the Tensorflow deep learning framework.

Specifically, the neural network includes a first convolution module, a second convolution module, a pooling module, a nonlinear function activation module, a global average pooling module and a full connection module. The first convolution module and the second convolution module and the global average pooling module are all connected. The second convolution module, the pooling module and the nonlinear function activation module are connected in sequence. The global average pooling module is connected to the full connection module. The first convolution module is used to perform a convolution operation on the image, the second convolution module is used to perform a convolution operation on the first feature map, the pooling module is used to perform a pooling operation, the nonlinear function activation module is used to perform nonlinear function activation operations, the global average pooling module is used to perform global average pooling operations, and the full connection module is used to perform full connection operations.

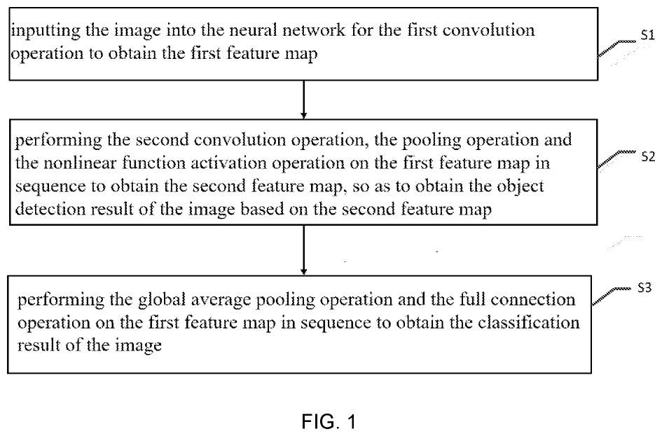

As shown in FIG. 1, in one embodiment, the synchronous processing method of image classification and object detection of the present disclosure includes the following steps.

Step S1: inputting the image into the neural network for the first convolution operation to obtain the first feature map.

Specifically, after the image is input into the first convolution module, the first feature map of the image can be obtained through a convolution operation. In an example, the pixels of the first feature map are 26*26*512.

Step S2: performing a second convolution operation, a pooling operation and a nonlinear function activation operation on the first feature map in sequence to obtain a second feature map, so as to obtain the object detection result of the image based on the second feature map.

Specifically, a convolution kernel of 75*3*3 is adopted to perform sequentially a second convolution operation, a pooling operation, and a nonlinear function activation operation on the first feature map to obtain a second feature map with 26*26*75 pixels.

Step S3: performing a global average pooling operation and a full connection operation on the first feature map in sequence to obtain the classification result of the image.

Specifically, after performing a global average pooling operation on the first feature map, 512 numbers are obtained, and after performing a full connection operation on the 512 numbers, 1000 numbers obtained are used as the classification results.

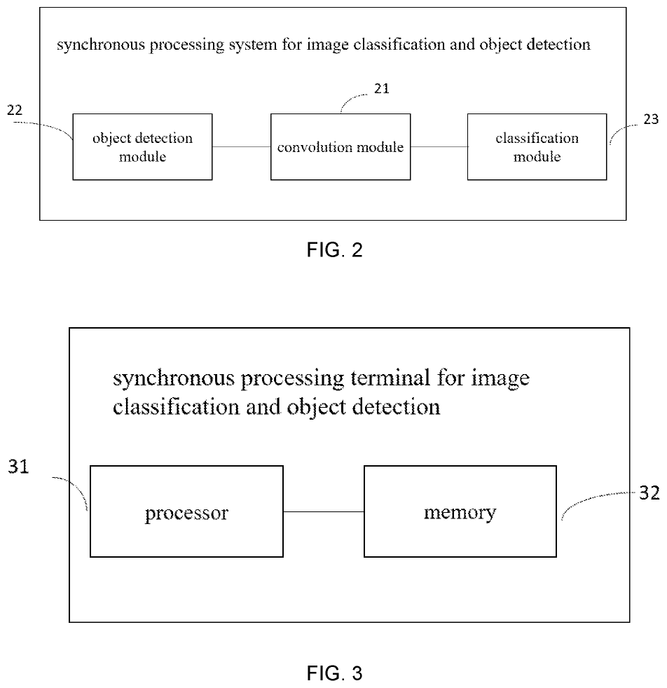

As shown in FIG. 2, in one embodiment, the synchronous processing system for image classification and object detection of the present disclosure includes a convolution module 21, an object detection module 22 and a classification module 23.

The convolution module 21 is used to input the image into the neural network to perform a convolution operation to obtain the first feature map.

Specifically, after the image is input into the first convolution module, the first feature map of the image can be obtained through a convolution operation. In one example, the pixels of the first feature map are 26*26*512.

The object detection module 22 is connected to the convolution module 21 and the object detection module 22 sequentially performs a convolution operation, a pooling operation and a non-linear function activation operation on the first feature map, to obtain a second feature map, thus obtaining the object detection results of the image based on the second feature map.

Specifically, a convolution kernel of 75*3*3 is used to sequentially perform the convolution operation, pooling operation, and nonlinear function activation operation on the first feature map, so as to obtain a second feature map of 26*26*75 pixels.

The classification module 23 is connected to the convolution module 21 and is used to sequentially perform a global average pooling operation and a full connection operation on the first feature map, so as to obtain the classification results of the image.

Specifically, after performing a global average pooling operation on the first feature map, 512 numbers are obtained, and after performing a full connection operation on the 512 numbers, 1000 numbers are obtained as the classification results.

It should be noted that modules of the above device are set up based on their logical functions. In actual implementation, multiple modules can be fully or partially integrated into physical entities, or each module can also be physically separated. And all of the modules can be implemented in the form of software calling through processing components; they can also be implemented in the form of hardware. Also, a portion of the modules can be implemented in the form of software calling through processing components, and a portion of the modules can be implemented in the form of hardware. For example, one exemplary x module can be a separate processing unit or integrated in one of the chips of the above device, and furthermore, it can also in the form of program codes stored in the above device, which being called and executed by one of the processing elements of the above device to perform the functions of the above x module. The implementation of other modules can be done in similar ways. In addition, all or part of these modules can be integrated together or implemented independently. The processing element described here may be an integrated circuit with signal processing capabilities. During the implementation process, each step of the above method or each of the above modules can be completed by the integrated logic circuits of hardware in the processor element or instructions that in the form of software.

For example, the above modules may be one or more integrated circuits configured to implement the above methods, such as: one or more Application Specific Integrated Circuits (ASICs for short), or one or more microprocessors like the Digital Signal Processor (DSP for short), or one or more Field Programmable Gate Array (FPGA for short)), etc. For another example, when one of the above modules is implemented in the form of program codes that are called by a processing element, the processing element can be a general-purpose processor, such as a Central Processing Unit (CPU for short) or other processors that can call program codes. For another example, these modules can be integrated together and implemented in the form of a System-On-a-Chip (SOC for short).

A computer program is stored on the storage medium of the present disclosure. When the program is executed by the processor, the above-mentioned synchronous processing method for image classification and object detection is implemented. The storage media includes: ROM, RAM, magnetic disks, USB disks, memory cards or optical disks and other media that can store program codes.

As shown in FIG. 3, in one embodiment, the synchronous processing terminal for image classification and object detection of the present disclosure includes: a processor 31 and a memory 32.

The memory 32 stores computer programs.

The memory 32 includes various media that can store program codes, such as ROM, RAM, magnetic disks, USB disks, memory cards or optical disks.

The processor 31 is connected to the memory 32 and is used to execute the computer program stored in the memory 32, so that the synchronous processing terminal for image classification and object detection executes the above-mentioned synchronous processing method for image classification and object detection.

Preferably, the processor 31 may be a general-purpose processor, including a Central Processing Unit (CPU for short), a Network Processor (NP for short), etc.; it may also be a Digital Signal Processor (DSP for short), an Application Specific Integrated Circuit (ASIC for short), a Field Programmable Gate Array (FPGA for short) or other programmable logic devices, discrete gates or transistor logic devices, and discrete hardware components.

In summary, the synchronous processing method, system, storage medium and terminal of the present disclosure for image classification and object detection perform image classification and object detection simultaneously through the same neural network, so the technique is fast and efficient, thus having low calculation complexity and effectively reducing the system load. It is feasible, effective and highly practical in many actual application scenarios. The present disclosure effectively overcomes various shortcomings in the existing techniques and has high industrial utilization value.

The above embodiments only illustrate the principles and effects of the present disclosure, but are not intended to limit the present disclosure. Anyone familiar with this technology can modify or change the above embodiments without departing from the spirit and scope of the present disclosure. Therefore, all equivalent modifications or changes made by those with ordinary knowledge in the technical field without departing from the spirit and technical ideas disclosed in the present disclosure shall still be covered by the claims of the present disclosure.

1. A synchronous processing method for image classification and object detection, comprising following steps:
inputting an image into a neural network;
performing a first convolution operation on the image to obtain a first feature map;
performing in sequence a second convolution operation, a pooling operation and a nonlinear function activation operation on the first feature map to obtain a second feature map;
obtaining an object detection result of the image based on the second feature map; and
performing in sequence a global average pooling operation and a full connection operation on the first feature map to obtain a classification result of the image;
wherein the neural network comprises a first convolution module, a second convolution module, a pooling module, a nonlinear function activation module, a global average pooling module, and a full connection operation module;
wherein the first convolution module is connected to the second convolution module and the global average pooling module, and wherein the second convolution module, pooling module and nonlinear function activation module are connected in sequence, and wherein the global average pooling module is connected to the full connection operation module;
wherein the first convolution module performs the first convolution operation on the image to obtain the first feature map, wherein the second convolution module performs the second convolution operation on the first feature map; and
wherein the pooling module performs the pooling operation, wherein the nonlinear function activation module performs the nonlinear function activation operation, and wherein the global average pooling module performs the global average pooling operation, and wherein the full connection operation module performs the full connection operation.

2. The synchronous processing method of claim 1, wherein the neural network comprises Mobilenet neural network.

3. (canceled) The synchronous processing method of claim 1, wherein the neural network comprises a first convolution module, a second convolution module, a pooling module, a nonlinear function activation module, a global average pooling module, and a full connection operation module;
wherein the first convolution module is connected to the second convolution module and the global average pooling module, and wherein the second convolution module, pooling module and nonlinear function activation module are connected in sequence, and wherein the global average pooling module is connected to the full connection operation module;
wherein the first convolution module performs the first convolution operation on the image to obtain the first feature map, wherein the second convolution module performs the second convolution operation on the first feature map; and
wherein the pooling module performs the pooling operation, wherein the nonlinear function activation module performs the nonlinear function activation operation, and wherein the global average pooling module performs the global average pooling operation, and wherein the full connection operation module performs the full connection operation.

4. The synchronous processing method of claim 1, wherein the first feature map comprises 26*26*512 pixels.

5. The synchronous processing method of claim 4, wherein the second convolution operation applies a convolution kernel of 75*3*3 to the first feature map, and wherein the obtained second feature map comprises 26*26*75 pixels.

6. The synchronous processing method of claim 4, further comprising, PATENT after performing the global average pooling operation on the first feature map, obtaining 512 numbers; and
after performing the full connection operation on the 512 numbers, obtaining 1000 numbers, wherein the 1000 numbers are used as the classification results of the image.

7. The synchronous processing method of claim 1, wherein the neural network comprises the Tensorflow deep learning framework.

8. A synchronous processing system for image classification and object detection, comprising: a convolution module, an object detection module, and a classification module;
wherein the convolution module inputs an image to a neural network for a first convolution operation to obtain a first feature map;
wherein the object detection module sequentially performs a second convolution operation, a pooling operation and a nonlinear function activation operation on the first feature map to obtain a second feature map, based on the second feature map to acquire an object detection result of the image; and
wherein the classification module sequentially performs a global average pooling operation and a full connection operation on the first feature map to obtain a classification result of the image;
wherein the neural network comprises a first convolution module, a second convolution module, a pooling module, a nonlinear function activation module, a global average pooling module, and a full connection operation module;
wherein the first convolution module is connected to the second convolution module and the global average pooling module, and wherein the second convolution module, pooling module and nonlinear function activation module are connected in sequence, and wherein the global average pooling module is connected to the full connection operation module;
wherein the first convolution module performs the first convolution operation on the image to obtain the first feature map, wherein the second convolution module performs the second convolution operation on the first feature map; and
wherein the pooling module performs the pooling operation, wherein the nonlinear function activation module performs the nonlinear function activation operation, and wherein the global average pooling module performs the global average pooling operation, and wherein the full connection operation module performs the full connection operation.

9. A storage medium with a computer program stored thereon, wherein when the computer program is executed by a processor, the synchronous processing method according to claim 1 is implemented

10. A synchronous processing terminal for image classification and object detection, comprising: a processor and a memory, wherein the memory stores computer programs; and wherein the processor executes the computer programs stored in the memory, so that the synchronous processing terminal executes the synchronous processing method according to claim 1.
